(19) United States
(12) Patent Application Publication
(10) Pub. No.: US 2025/0237782 A1
(43) Pub. Date: Jul. 24, 2025

(54) ANALOG INFORMATION BARRIER (AIB) WINDOW SETTING ELECTRONICS FOR AN AIB AND METHOD FOR OPERATING AN AIB

(71) Applicant: Battelle Energy Alliance, LLC, Idaho Falls, ID (US)

(72) Inventors: David L. Chichester, Idaho Falls, ID (US); James T. Johnson, Rigby, ID (US); Jay D. Hix, Idaho Falls, ID (US); Edward H. Seabury, Idaho Falls, ID (US)

(21) Appl. No.: 19/005,889

(22) Filed: Dec. 30, 2024

Related U.S. Application Data
(60) Provisional application No. 63/624,213, filed on Jan. 23, 2024.

(51) Int. Cl. G01V 5/22; G01N 23/095

(52) U.S. Cl. CPC G01V 5/22; G01N 23/095

(57) ABSTRACT

An analog information barrier (“aIB”) includes a detector configured to provide an output signal in response to an input received at the detector. The aIB further includes a window setting electronics portion configured receive a first portion of the output signal to be blocked by the analog information barrier, to receive a second portion of the output signal to be allowed by the analog information barrier based on one or more region of interest windows, and to output a windowed output signal that corresponds to the second portion of the output signal based on the one or more region of interest windows. The aIB also includes a output device configured to receive the windowed output signal and provide an output based on the second portion of the output signal. Methods for operating an aIB and window setting electronics for an aIB are also disclosed.

### CROSS-REFERENCE TO RELATED APPLICATION

This application claims the benefit under 35 U.S.C. § 119(e) of U.S. Provisional Patent Application Ser. No. 63/624,213, filed Jan. 23, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to control of information output from one or more detection devices. More specifically, the disclosure relates to an analog information barrier that may be used to control information output in radiation spectrometry or other applications.

### BACKGROUND

Spectrometry may be used in several applications to obtain information regarding properties of an observed spectrometry target. For example, gamma-ray spectrometry may be used to detect decaying radionuclides and identify the radionuclides using gamma spectroscopy. Accordingly, gamma-ray spectrometry may be used in certain applications to obtain information about a detection target such as nuclear material in a device.

In some instances, spectrometry may be useful in fields such as arms control verification which may be required in treaties or agreements between countries. However, direct gamma-ray spectrometry of a treaty accountable item may reveal sensitive information (e.g., classified, proprietary, or confidential information) about the item. To address this, spectrometry measurements are often used in conjunction with a so-called “information barrier.” Conventional information barriers utilize a combination of hardware and software to detect information and allow only non-sensitive information to be revealed to the operator. Conventional information barriers also ensure that the revealed information accurately reflects the measured conditions.

### BRIEF SUMMARY

According to some embodiments of the disclosure, an analog information barrier (“aIB”) includes a detector configured to provide an output signal in response to an input received at the detector. The aIB further includes a window setting electronics portion configured to receive a first portion of the output signal to be blocked by the analog information barrier, to receive a second portion of the output signal to be allowed by the analog information barrier based on one or more region of interest windows, and to output a windowed output signal that corresponds to the second portion of the output signal based on the one or more region of interest windows. The aIB includes an output device configured to receive the windowed output signal and provide an output based on the second portion of the output signal.

According to some embodiments of the disclosure, a method for operating an analog information barrier includes authenticating the analog information barrier with a reference target by detecting known electromagnetic radiation from the reference target with the analog information barrier operating in a full-spectrum detection mode, deactivating the full-spectrum detection mode, activating a windowed spectrum detection mode, and certifying a detection target with the analog information barrier in the windowed spectrum detection mode.

According to some embodiments of the disclosure, window setting electronics for an analog information barrier are provided. The window setting electronics include a first single-channel analyzer comprising a first region of interest window configured to generate a logic pulse voltage when an input voltage is within the first region of interest window, and a second single-channel analyzer comprising a second region of interest window configured to generate a logic pulse voltage signal when the input voltage is within the second region of interest window.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 shows a schematic of an analog information barrier according to some embodiments of the disclosure;

FIG. 2 shows a graph of an exemplary output of an analog information barrier according to some embodiments of the disclosure;

FIG. 3 shows a method of operating an analog information barrier according to some embodiments of the disclosure; and

FIG. 4 shows a schematic of an analog information barrier according to some embodiments of the disclosure.

### DETAILED DESCRIPTION

The illustrations presented herein are not actual views of any analog information barrier, or any component thereof, but are merely idealized representations, which are employed to describe embodiments of the disclosure.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any analog information barrier when utilized in a conventional manner. Furthermore, these terms may refer to an orientation of elements of any analog information barrier as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” in reference to a numerical value may include additional numerical values within a range of from 90.0 percent to 108.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

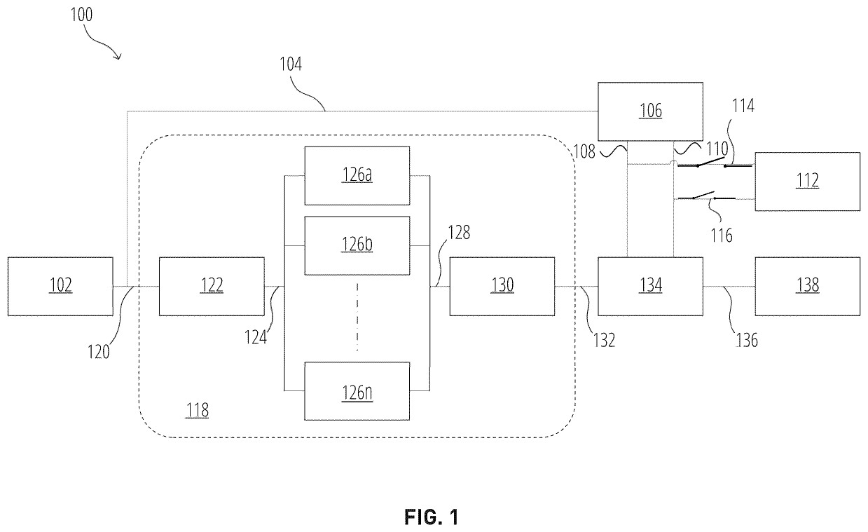

FIG. 1 shows a schematic of an analog information barrier according to some embodiments of the disclosure. An analog information barrier (“aIB”) 100 may be configured to prevent sensitive information from being revealed to a party while allowing non-sensitive information to be revealed to a party (e.g., an operator) from a given sensor. The aIB 100 may further be configured to provide verification that the revealed information accurately reflects measured conditions.

In conventional information barriers, a combination of hardware and software is utilized to allow the desired non-sensitive information to be revealed from a given sensor. In such information barriers, it may be difficult for parties to verify that the revealed information accurately reflects the measured conditions. This is because such information barriers operate as a so-called “black box” and cannot provide the authentication and transparency that is often desired by parties utilizing the information barrier.

The aIB 100 may be configured as an analog device that relies on analog hardware components, without the need for digital spectrometry hardware or software. By omitting the digital spectrometry hardware and software, the aIB 100 may provide a transparent and authenticable system for providing an information barrier when observing a detection target. In this sense, transparency may include the goal of a host party to ensure the equipment is safe and does not exhibit undeclared capabilities that might directly or indirectly reveal sensitive information. During use and operation of the aIB 100, spectral signatures from region of interest windows may be detected, while spectral signatures from a full spectrum that are outside the region of interest windows may be masked. The aIB 100 may, therefore, enable non-sensitive information pertaining to the detection target to be revealed to an operator of the aIB 100 while sensitive information pertaining to the detection target is not revealed to the operator. The aIB 100 may be used in nuclear security applications, such as in arms control and treaty verification.

As shown in FIG. 1, the aIB 100 may comprise a sensor or detector 102 for detecting radiation. The detector 102 may be any suitable detector depending on the application for the aIB 100. In some embodiments, the detector 102 may comprise a spectrometer that is configured to detect radiation, such as gamma radiation. The radiation may be emitted by a nuclear material or another material, such as a high explosive, combined with the nuclear material. The detector 102 may, for example, be configured to detect gamma radiation. However, other types of radiation may be detected by appropriately selecting the detector 102. For instance, the detector 102 may be configured to detect specific radioisotopes or to detect a high explosive material within a nuclear material. In some embodiments, such as for applications involving nuclear arms testing for treaty compliance, the detector 102 may comprise a gamma-ray spectrometer. For example, the detector 102 may comprise an n-type, high-purity germanium (HPGe) gamma-ray spectrometer. The detector 102 may be configured to detect a physical phenomenon, such as energy of electromagnetic radiation, and provide an output such as a voltage corresponding to the detected input. The detector 102 may be configured to detect prompt gamma-ray neutron activation analysis (PGNAA) neutron-capture gamma rays and other PGNAA signatures from high explosive materials, such as those emitted from the capture of thermal neutrons in hydrogen and nitrogen. Neutrons produced in the decay of plutonium (Pu) or other actinide isotopes may also be detected by the detector 102. While the detector 102 is shown as a single unit in FIG. 1, the detector 102 may comprise multiple different detectors.

An output from the detector 102 may be split to include a first output signal 104 that may be received by a first amplifier 106. The first amplifier 106 may be configured to amplify the first output signal 104. In some embodiments, the first amplifier 106 may be configured to receive an entire, unblocked signal from the detector 102. For example, the first output signal 104 received at the first amplifier 106 may comprise an output from the detector 102 corresponding to the full spectrum of energy that is able to be detected by the detector 102. The first amplifier 106 may be referred to as a full-spectrum amplifier. In some embodiments, the first amplifier 106 may comprise a slow response time, such as having a delay of about 2.5 μs from the first output signal 104.

The first amplifier 106 may output a first amplifier output signal 108 and a second amplifier output signal 110. The first amplifier output signal 108 may comprise a pile-up rejection and/or busy signal. The second amplifier output signal 110 may comprise an amplified, full-spectrum output. The amplified, full-spectrum output may correspond to an output of the detector 102 that has not had any information removed from the first output signal 104.

The first amplifier output signal 108 and the second amplifier output signal 110 may be input to a first multi-channel analyzer 112. The first multi-channel analyzer 112 may comprise an analog-to-digital converter and may be configured to output information to an output device, such as a general purpose computer, a digital hand-held device, or the like.

The first output signal 104, the first amplifier 106 and the first multi-channel analyzer 112 may also be configured to allow for validation, transparency, and calibration. For example, the detector 102 may be positioned to detect a reference target. For example, a reference target may comprise a known source of electromagnetic radiation. The detector 102 may detect the electromagnetic radiation from the reference target, the first output signal 104 may be provided to the first amplifier 106, and the first amplifier 106 may output the first and second amplifier output signals 108, 110 to the first multi-channel analyzer 112. An output from the first multi-channel analyzer 112 may be used to validate the aIB 100 for accuracy, to provide transparency during an inspection process, and/or to calibrate the detector 102 or other components of the aIB 100. The first multi-channel analyzer 112 may be referred to as a full-spectrum multi-channel analyzer and an output from the first multi-channel analyzer 112 may be referred to as a full-spectrum output. When the aIB 100 is configured to provide an output from the first multi-channel analyzer 112, the aIB may be considered to operate in a full-spectrum detection mode.

When the aIB 100 is to be used to allow the desired non-sensitive information to be revealed to a party while restricting the sensitive information, the first multi-channel analyzer 112 may be disconnected from the aIB 100 to ensure that no sensitive information is output from the aIB 100. The aIB 100 may comprise a first switch 114 that is configured to disconnect the first multi-channel analyzer 112 from the first amplifier output signal 108 and a second switch 116 that is configured to disconnect the first multi-channel analyzer 112 from the second amplifier output signal 110. The first switch 114 and second switch 116 are merely exemplary, and other methods of disconnecting the first multi-channel analyzer 112 from the first amplifier output signal 108 and second amplifier output signal 110 may be used, such as by removing a physical cable connection. The disconnection of the first multi-channel analyzer 112 from aIB 100 ensures that the parties do not reveal sensitive information when the aIB 100 is configured to allow the desired, non-sensitive information to be revealed.

The aIB 100 may further comprise a window-setting electronics portion 118 that operates as the information barrier portion of the aIB 100. The window-setting electronics portion 118 may be configured to receive a second output signal 120 from the detector 102. The second output signal 120 may be received at a signal conditioner 122. The signal conditioner 122 may include, but is not limited to, an amplifier, a noise filter, a delay line amplifier, or any combination of these or other components to condition or filter the second output signal 120 received by the window-setting electronics portion 118. The signal conditioner 122 may comprise a relatively fast response time (e.g., as compared to the first amplifier 106).

The signal conditioner 122 may output a conditioned signal 124 which may be split to be input into a plurality of single-channel analyzers 126a, 126b . . . 126n. Each of the single-channel analyzers 126a, 126b . . . 126n may be configured to comprise a voltage window (e.g., a region of interest window) between two voltage levels. When one of the single-channel analyzers 126a, 126b . . . 126n receives a voltage input from the conditioned signal 124 between the two voltage levels of the voltage window, the single-channel analyzer 126a, 126b . . . 126n produces a logic pulse voltage 128. In some embodiments, the single-channel analyzers 126a, 126b . . . 126n may produce the logic pulse voltage 128 at about 500 ns from the second output signal 120.

The window-setting electronics portion 118 may comprise any predetermined number of single-channel analyzers 126a, 126b . . . 126n based on a given application. For example, a first single-channel analyzer 126a may comprise a first window that is configured to receive a voltage from the conditioned signal 124 corresponding to a relatively lower energy gamma ray, and a second single-channel analyzer 126b may comprise a second window that is configured to receive a voltage from the conditioned signal 124 corresponding to relatively higher energy gamma ray. The voltage windows of each of the single-channel analyzers 126a, 126b . . . 126n may be configured to detect certain predetermined voltages of the conditioned signal 124 and to output the logic pulse voltage 128 when the predetermined voltages are detected. When the conditioned signal 124 comprises a voltage outside of the voltage windows of each of the single-channel analyzers 126a, 126b . . . 126n, no logic pulse voltage 128 is produced by the single-channel analyzers 126a, 126b . . . 126n. Therefore, the single-channel analyzers 126a, 126b . . . 126n may provide the logic pulse voltage 128 to identify voltages in the first output signal 104 that are non-sensitive or allowed, while also identifying voltages in the first output signal 104 that are sensitive or are otherwise not allowed to be revealed to an operator of the aIB 100. The predetermined voltage windows of the predetermined number of single-channel analyzers 126a, 126b . . . 126n may thus operate as an information barrier of information sensed by the detector 102. While the single-channel analyzers 126a, 126b . . . 126n are shown as separate units, the single-channel analyzers 126a, 126b . . . 126n may each be part of a single unit.

The type of information sensed by the detector 102 that is identified via the single-channel analyzers 126a, 126b . . . 126n of the window-setting electronics portion 118 may be based on any number of factors. For example, voltages outside of the voltage windows of the single-channel analyzers 126a, 126b . . . 126n may correspond to information that is sensitive or classified, while voltages within the voltage windows of the single-channel analyzers 126a, 126b . . . 126n may correspond to non-sensitive information, e.g., information for inspection compliance with one or more treaties. In another example, voltages outside the voltage windows of the single-channel analyzers 126a, 126b . . . 126n may correspond to confidential or proprietary information, while voltages within the voltage windows of the single-channel analyzers 126a, 126b . . . 126n may correspond to non-sensitive information. In some examples, the voltage windows of the single-channel analyzers 126a, 126b . . . 126n may be selected to view narrow spectral regions, such as spectral regions corresponding to hydrogen (2223.2 keV) and nitrogen (9807.2 keV, 10318.2 keV, and 10829.2 keV), prompt gamma-ray neutron activation analysis (“PGNNA”) signatures, neutron-capture gamma rays, and other PGNAA signatures, which are present in many high explosive materials that contain hydrogen and nitrogen.

The logic pulse voltage 128 from the single-channel analyzers 126a, 126b . . . 126n may be sent to a delay generator 130 or other signal conditioner. The delay generator 130 may output a delayed signal 132 to a gated amplifier 134. In some embodiments, the delay generator 130 may be configured to make a 20 μs gate pulse as the delayed signal 132 based on the presence or absence of the logic pulse voltage 128 from the single-channel analyzers 126a, 126b . . . 126n.

The gated amplifier may be configured to receive the second amplifier output signal 110 from the first amplifier 106. Based on the delayed signal 132 (e.g., based on the presence or absence of a logic pulse voltage from one of the single-channel analyzers 126a, 126b . . . 126n), the gated amplifier 134 may be configured to amplify or mute the second amplifier output signal 110. For example, when the gated amplifier 134 receives the delayed signal 132 indicating the presence of a logic pulse voltage 128 from one of the single-channel analyzers 126a, 126b . . . 126n, the gated signal may amplify the second amplifier output signal 110 received from the first amplifier 106. When the gated amplifier 134 receives the delayed signal 132 that does not indicate the presence of a logic pulse voltage 128 from one of the single-channel analyzers 126a, 126b . . . 126n, the gated amplifier 134 is configured to mute the second amplifier output signal 110 received from the first amplifier 106.

In this way, the gated amplifier 134 is configured to provide a windowed output signal 136. Based on the delayed signal 132, the gated amplifier 134 may be configured to reject or mute signals from the second amplifier output signal 110 not falling within predetermined voltage or region of interest windows. The windowed output signal 136 may be sent to a second multi-channel analyzer 138. The second multi-channel analyzer 138 may comprise a digital-to-analog converter and may provide an output to a general-purpose computer, a digital hand-held device, or the like based on the windowed output signal 136. The second multi-channel analyzer 138 may be referred to as a windowed multi-channel analyzer and an output of the second multi-channel analyzer 138 may be referred to as a windowed output or a region of interest windowed spectrum output. When the aIB 100 is configured to provide an output from the second multi-channel analyzer 138, the aIB 100 may be considered to operate in a windowed spectrum detection mode.

The information provided by the aIB 100 through the use of the window-setting electronics portion 118 may provide only a desired portion of the information sensed by the detector 102, which may be predetermined as non-sensitive, allowed information, to be passed through to an output device. This may allow one or more operators to authenticate the predetermined allowed information, such as information required by compliance with a treaty, without other information, such as sensitive or classified information, being revealed about a detection target.

In some embodiments, when the aIB 100 is operating in the windowed spectrum detection mode, the first amplifier output signal 108 comprising a pile-up rejection and/or busy signal may not be sent to the second multi-channel analyzer 138 providing the region of interest windowed spectrum output. Therefore, a true dead time for the measurement and, thus, a true live acquisition time information is lost and is not available for analysis. Because of this, it is not possible to correlate gamma-ray signal intensities to true emission rates from a detection target being sensed by the detector 102, which may be used to infer sensitive information to the parties. This precludes the ability to infer information about certain properties of the detection target, such as isotopic information or masses about the Pu in the detection target because the true count rate as detected from the detection target is blocked.

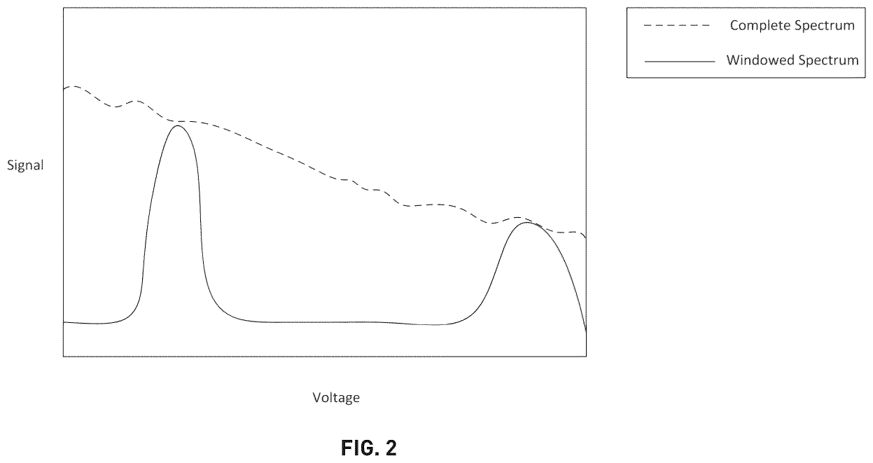

FIG. 2 shows a graph of an exemplary output of an analog information barrier according to some embodiments of the disclosure. In FIG. 2, a full spectrum or complete spectrum output is shown as a broken line in the graph. The full spectrum output may correspond to an output of the aIB 100 from the first multi-channel analyzer 112. For example, the full spectrum output may include all of the data sensed by the detector 102 over its detection range. A windowed spectrum output is shown in solid line in the graph of FIG. 2. The windowed spectrum output may correspond to an output from the second multi-channel analyzer 138. As shown in FIG. 2, the windowed spectrum output may provide an output only over certain voltage windows. The voltage windows may correspond to the voltage windows of the single-channel analyzers 126a, 126b . . . 126n. In this way, only certain portions of the information detected by the detector 102 may be passed through the aIB 100.

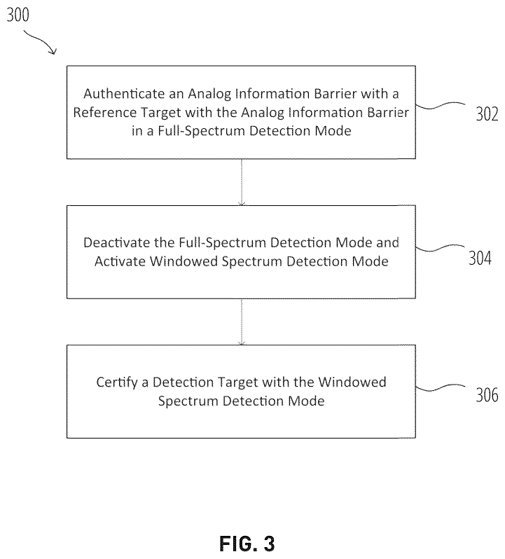

FIG. 3 shows a method 300 of operating an analog information barrier according to some embodiments of the disclosure. In act 302 of the method 300, the aIB, such as aIB 100 shown in FIG. 1, is authenticated with a reference target with the aIB 100 operating in a full-spectrum detection mode. For example, when detecting electromagnetic radiation, the detector 102 of the aIB 100 may be used to detect a reference target which may be an object or other source of electromagnetic radiation that has known properties. The detector 102 of the aIB 100 may detect the reference target and an output may be provided from the first multi-channel analyzer 112, which is configured to be connected to the first amplifier output signal 108 and the second amplifier output signal 110 via the first switch 114 and the second switch 116. The output may be a “full spectrum” output (e.g., an output of the full spectrum of information that the detector 102 of the aIB 100 is capable of detecting). For example, the output may be based on the first and second amplifier output signals 108, 110 provided from the first output signal 104 and the first amplifier 106. The output of the aIB 100 may be authenticated or calibrated based on the known properties of the reference target being detected. In the context of use of the aIB 100, the act 302 may allow parties to verify (e.g., trust) information being output by the aIB 100 by comparing the output of the aIB 100 to the known properties of the reference target.

In act 304, the full-spectrum detection mode of the aIB 100 is deactivated, and the windowed spectrum detection mode is activated. Once the aIB 100 is authenticated and/or calibrated, the aIB 100 may be configured such that the full-spectrum output from the first multi-channel analyzer 112 is deactivated. In some examples, this may be done by disconnecting the second amplifier output signal 110 which may comprise the amplified, full-spectrum output from the detector 102 from the first multi-channel analyzer 112 via the second switch 116. In some embodiments, a lead with the second amplifier output signal 110 may be unplugged from the first multi-channel analyzer 112. In some embodiments, the first amplifier output signal 108 may be disconnected from the first multi-channel analyzer 112 via the first switch 114. The second multi-channel analyzer 138 may then operate as the active output of the aIB 100. The full spectrum detection may be deactivated via switching device (e.g., via the first switch 114 and second switch 116), removing one or more cables or connectors from the first multi-channel analyzer 112, or the like. The activated, windowed spectrum detection mode may be used to detect spectral signatures in the predetermined windows.

In act 306, the aIB 100 may be used to certify a detection target in a windowed spectrum detection mode. With the aIB 100 in a windowed spectrum detection mode where the output of the aIB 100 is from the second multi-channel analyzer 138, allowed or non-sensitive information regarding the detection target may be certified by the aIB 100. As explained above, the aIB 100 may utilize the window-setting electronics portion 118 with the plurality of single-channel analyzers 126a, 126b . . . 126n along with the gated amplifier 134 to block or mute certain information detected by the detector 102 while passing through allowed information detected by the detector 102. The information passed through based on the window-setting electronics portion 118 may allow the operator to certify information about the detection target while other information about the detection target is blocked which may be sensitive, classified, proprietary, or otherwise limited from the operator.

In some examples, during calibration, testing, and authentication and certification, an operator of the aIB 100 may observe both the full spectrum output and the region of interest windowed spectrum output using a reference target such as a non-sensitive calibration aid. In some examples, the non-sensitive calibration aid may comprise a cylinder made of mock high explosives that contains, for example, a ²⁵²Cf source to boost the neutron signature. By using the reference target, the operator may confirm that the data from the region of interest windowed spectrum matches data from the full spectrum. In this manner, the operator may verify that the system can detect desired spectral regions, such as spectral regions corresponding to hydrogen and nitrogen. When a detection target is analyzed, such as a treaty accountable item, the full spectrum output may be switched off (e.g., the first switch 114 and the second switch 116 may be switched to disconnect the first multi-channel analyzer 112 from the first amplifier output signal 108 and second amplifier output signal 110) or a cable passing the full spectrum data from the spectroscopy amplifier (e.g., the first amplifier 106) to the first multi-channel analyzer 112 (e.g., a cable for connecting the first amplifier output signal 108 and/or the second amplifier output signal 110 to the first multi-channel analyzer 112 shown in FIG. 1) may be physically removed, eliminating the ability of the operator to observe sensitive spectral information, such as from the decay gamma-rays of Pu, Am, or other signatures that may not pass through the information barrier based on the selected region of interest windows.

The above described aIB 100 and method 300 may provide for an information barrier that is constructed and operable via analog electronics devices (e.g., hardware devices) without the need for software. Because no software is utilized, the aIB 100 and method 300 may be authenticated and trusted by parties utilizing the aIB 100 and method 300 while also accurately detecting and passing through non-sensitive, allowable information about a detection target. Thus, the user may utilize the aIB 100 and method 300 to certify allowable information about a detection target while blocking or withholding other information which may be classified, proprietary, or otherwise limited to one or more of the parties.

The aIB 100 and method 300 may provide several advantages over conventional information barriers in several use scenarios including for authenticating an arms control measurement system. The aIB 100 may be constructed from readily understood components which may provide increased transparency. The inspection process may be simplified and may be easier than with conventional information barriers. The aIB 100 further provides the ability to perform tests of the aIB 100 against known, non-sensitive objects during a measurement sequence. The aIB 100 may be able to use modular and minimally functional parts to increase reliability. Further, the aIB 100 may provide the ability to maintain continuity of knowledge of the system following initial authentication.

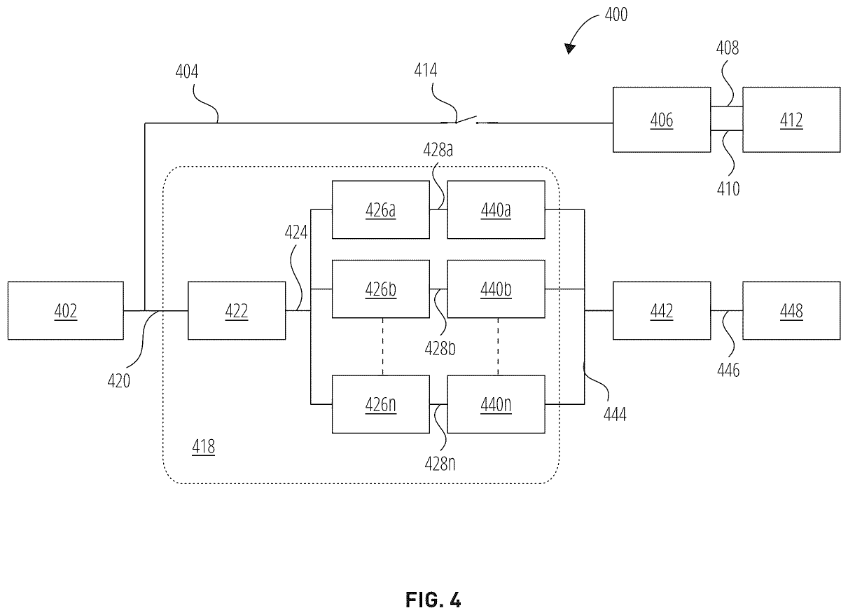

Other modifications of the aIB 100 are within the scope of the disclosure. For example, FIG. 4 shows a schematic view of an analog information barrier (“aIB”) 400. To avoid repetition, not all features shown in FIG. 4 are described in detail herein. Rather, unless described otherwise below, in FIG. 4, a feature designated by a reference numeral that is a 300 increment of the reference numeral of a feature previously described with reference to FIG. 1 will be understood to be substantially similar to the previously described feature. By way of non-limiting example, unless described otherwise below, features designated by the reference numerals 404 and 412 in FIG. 4, respectively, will be understood to be substantially similar to the first output signal 104 and first multi-channel analyzer 112 previously described with reference to FIG. 1.

In FIG. 4, the aIB 400 may utilize a window-setting electronics portion 418 to certify the presence or absence of non-sensitive information to be revealed to a party (e.g., an operator) without providing any part of the original signal of a detector 402. The single-channel analyzers 426a, 426b . . . 426n may each be configured to provide a respective voltage pulse 428a, 428b . . . 428n in response to detecting a signal within a predetermined voltage window. The voltage pulses 428a, 428b . . . 428n are received by respective analog devices 440a, 440b . . . 440n. For example, the analog devices 440a, 440b . . . 440n may comprise counters that count the voltage pulses 428a, 428b . . . 428n output from each of the single-channel analyzers 426a, 426b . . . 426n. In some embodiments, the analog devices 440a, 440b . . . 440n may comprise scalers. While FIG. 4 shows a one-to-one correspondence between analog devices 440a, 440b . . . 440n and single-channel analyzers 426a, 426b . . . 426n, there may be one analog device 440a, 440b . . . 440n for pairs of single-channel analyzers 426a, 426b . . . 426n, one analog device 440a, 440b . . . 440n for a group of three single-channel analyzers 426a, 426b . . . 426n, and so forth.

The analog devices 440a, 440b . . . 440n may output a windowed output signal 444 to a Boolean operator 442. The windowed output signal 444 may comprise a number of the voltage pulses 428a, 428b . . . 428n of each of the single-channel analyzers 426a, 426b . . . 426n, a scaled value corresponding to the number of the voltage pulses 428a, 428b . . . 428n of each of the single-channel analyzers 426a, 426b . . . 426n, values corresponding to the voltage pulses 428a, 428b . . . 428n of pairs or other groups of the single-channel analyzers 426a, 426b . . . 426n, or the like. The Boolean operator 442 may be configured to provide a certification signal 446 based on the received windowed output signal 444. The certification signal 446 may be a signal indicating the presence or absence of the non-sensitive information to be revealed by the aIB 400.

For example, the Boolean operator 442 may output a certification signal 446 indicating the presence of the non-sensitive information based on the windowed output signal 444 comprising a value that is above a predetermined threshold. As another example, the Boolean operator 442 may output a certification signal 446 indicating the presence of the non-sensitive information based on the windowed output signal 444 from two of the analog devices 440a, 440b . . . 440n having a ratio that exceeds a predetermined threshold. The Boolean operator 442 may set any other appropriate condition which, if met, causes the Boolean operator 442 to output the certification signal 446 indicating the presence of the non-sensitive information. If a predetermined condition set by the Boolean operator 442 is not met, the Boolean operator 442 may send a certification signal 446 indicating the absence of the non-sensitive information. The certification signal 446 is sent to a certification output device 448.

The certification output device 448 is configured to output the non-sensitive information of the aIB 400. The certification output device 448 may comprise any number of devices, such as an LED that is configured to light upon receiving the certification signal 446 indicating the presence of the non-sensitive information. The certification output device 448 may also comprise any other display and/or audio device that indicates the presence or absence of the non-sensitive information based on the certification signal 446.

In some embodiments, the Boolean operator 442 may be omitted, and the certification output device 448 may display one or more values based on the windowed output signal 444 from the analog devices 440a, 440b . . . 440n. For example, the certification output device 448 may be configured to display a sum provided from respective analog devices 440a, 440b . . . 440n corresponding to each of the single-channel analyzers 426a, 426b . . . 426n. An operator of the aIB 400 may thus be provided information about the presence or absence of the non-sensitive information while other sensitive information detected by the detector 402 is muted or blocked.

In the aIB 400, because no portion of the first amplifier output signal 408 or second amplifier output signal 410 is provided in the windowed spectrum detection mode, a switch 414 may be configured on the aIB 400 to disconnect the first output signal 404 from the first amplifier 406 to block the full spectrum output during the windowed spectrum detection mode. However, the switch 414 may also be configured to disconnect the first amplifier output signal 408 and/or the second amplifier output signal 410 from first multi-channel analyzer 412, similar to the configuration of the aIB 100 described above. Furthermore, other disconnection methods may also be used, such as removing one or more connectors from the first amplifier 406 and/or the first multi-channel analyzer 412.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. An analog information barrier comprising:
a detector configured to provide an output signal in response to an input received at the detector;
a window setting electronics portion configured to receive a first portion of the output signal to be blocked by the analog information barrier, to receive a second portion of the output signal to be allowed by the analog information barrier based on one or more region of interest windows, and to output a windowed output signal that corresponds to the second portion of the output signal based on the one or more region of interest windows; and
an output device configured to receive the windowed output signal and provide an output based on the second portion of the output signal.

2. The analog information barrier of claim 1, wherein the window setting electronics portion comprises a first single-channel analyzer and a second single-channel analyzer.

3. The analog information barrier of claim 2, wherein the first single-channel analyzer is configured to comprise a first region of interest window of the one or more region of interest windows and the second single-channel analyzer is configured to comprise a second region of interest window of the one or more region of interest windows.

4. The analog information barrier of claim 3, wherein the first region of interest window comprises a first spectral region corresponding to detection of hydrogen and the second region of interest window comprises a second spectral region corresponding to detection of nitrogen.

5. The analog information barrier of claim 2, wherein the window setting electronics portion comprises a signal conditioner configured to receive the output signal and to output a conditioned signal to the first and second single-channel analyzers.

6. The analog information barrier of claim 5, further comprising a gated amplifier configured to output the windowed output signal that corresponds to the second portion of the output signal based on the one or more region of interest windows of the window setting electronics portion.

7. The analog information barrier of claim 6, further comprising a windowed multi-channel analyzer configured to receive the windowed output signal and to output a region of interest windowed spectrum output.

8. The analog information barrier of claim 7, wherein the window setting electronics portion comprises a delay amplifier configured to receive logic pulse voltages from the first and second single-channel analyzers and to output a delayed signal to the gated amplifier, and the gated amplifier is configured to receive the delayed signal and to output the windowed output signal to the windowed multi-channel analyzer based on the delayed signal.

9. The analog information barrier of claim 1, wherein the output signal comprises a first output signal configured to bypass the window setting electronics portion and a second output signal configured to be received by the window setting electronics portion.

10. The analog information barrier of claim 9, further comprising a full-spectrum amplifier configured to receive the first output signal.

11. The analog information barrier of claim 10, further comprising a full-spectrum multi-channel analyzer configured to receive a first amplifier output signal and a second amplifier output signal from the full-spectrum amplifier and to output a full-spectrum output.

12. The analog information barrier of claim 11, wherein the first amplifier output signal comprises a pile-up rejection or busy signal and the second amplifier output signal comprises an amplified, full spectrum output signal.

13. The analog information barrier of claim 11, wherein the second amplifier output signal is configured to be selectively disconnected from the full-spectrum multi-channel analyzer.

14. The analog information barrier of claim 1, wherein the one or more region of interest windows comprise a first region of interest window corresponding to a first spectral region corresponding to detection of hydrogen and a second region of interest window corresponding to a second spectral region corresponding to detection of nitrogen.

15. The analog information barrier of claim 14, wherein the first region of interest window comprises a 2223.2 keV prompt gamma-ray neutron activation analysis (“PGNNA”) signature and the second region of interest window comprises 9807.2 keV, 10318.2 keV, and 10829.2 keV PGNNA signatures.

16. The analog information barrier of claim 2, wherein the window setting electronics portion comprises at least one analog device corresponding to one or both of the first single-channel analyzer or the second single-channel analyzer, the at least one analog device being configured to output the windowed output signal.

17. The analog information barrier of claim 16, wherein the at least one analog device comprises a counter or a scaler.

18. The analog information barrier of claim 16, further comprising a Boolean operator configured to receive the windowed output signal and to output a certification signal to the output device.

19. A method for operating an analog information barrier comprising:
authenticating the analog information barrier with a reference target by detecting known electromagnetic radiation from the reference target with the analog information barrier operating in a full-spectrum detection mode;
deactivating the full-spectrum detection mode;
activating a windowed spectrum detection mode; and
certifying a detection target with the analog information barrier in the windowed spectrum detection mode.

20. The method of claim 19, wherein deactivating the full-spectrum detection mode comprising disconnecting an amplifier output signal from a full-spectrum multi-channel analyzer of the analog information barrier.

21. The method of claim 19, wherein certifying the detection target comprises outputting information based on one or more region of interest windows of the windowed spectrum detection mode of the analog information barrier.

22. The method of claim 19, further comprising providing one or more region of interest windows in one or more single-channel analyzers of the analog information barrier.

23. Window setting electronics for an analog information barrier, the window setting electronics comprising:
a first single-channel analyzer comprising a first region of interest window configured to generate a logic pulse voltage when an input voltage is within the first region of interest window; and
a second single-channel analyzer comprising a second region of interest window configured to generate a logic pulse voltage signal when the input voltage is within the second region of interest window.

24. The window setting electronics of claim 23, wherein the first region of interest window comprises a first spectral region corresponding to detection of hydrogen and the second region of interest window comprises a second spectral region corresponding to detection of nitrogen.

25. The window setting electronics of claim 23, further comprising a signal conditioner configured to receive an output signal from a detector and to output a conditioned signal to the first and second single-channel analyzers.
